(19) United States
(12) Patent Application Publication
(10) Pub. No.: US 2005/0228542 A1
(43) Pub. Date: Oct. 13, 2005

(54) Auto-calibration method and device for wafer handler robots

(75) Inventors: Stanley W. Stone, Gloucester, MA (US); Paul J. Murphy, Reading, MA (US)

Correspondence Address: Mark Superko;Varian Semiconductor Equipment Associates, Inc., 35 Dory Lane, Gloucester, MA, 01930-2297, US

(73) Assignee: Varian Semiconductor Equipment Associates, Inc., Gloucester, MA (US)

(21) Appl. No.: 10/956,310

(22) Filed: Oct. 1, 2004

Related U.S. Application Data
(60) Provisional application No. 60/507,878, filed on Oct. 1, 2003.

(51) Int. Cl. G06F 19/00

(52) U.S. Cl. 700/245

(57) ABSTRACT

A method and system to calibrate a handler robot can include determining positions for stations between which the robot will transfer payloads, performing a transfer of a payload by the robot between the stations, measuring an offset and angle of the payload from the determined position of the station to which it was transferred and updating the determined position of that station based on the measured offset and angle.

### RELATED APPLICATIONS

This application claims priority under 35 U.S.C. § 119(e) to U.S. Provisional Patent Application Ser. No. 60/507,878, filed Oct. 1, 2003, entitled “Auto-Calibration Method and Device for Wafer Handler Robots,” the disclosure of which is hereby incorporated by reference.

### FIELD

The methods and systems relate to alignment of handler robots, and more particularly to auto-calibration of handler robots.

### BACKGROUND

Handler robots may be used to transfer payloads between stations, e.g., vacuum robots may be used in semiconductor manufacturing to transfer a wafer between load locks and the wafer orienter. Fixtures may be used at the stations to center the end effector or payload pick over the stations, so as to teach the robots the station positions. In order to minimize misplacement of the payload at its destination station, the taught positions may be at the center of the locations of the stations, or may be displaced in the same direction and magnitude relative to the station locations.

However, the mechanical equipment that may hold the payloads awaiting transfer may introduce errors in the payload placement in comparison to the fixture placement used to train the robots. Thus, subsequent operations performed on the payload may not provide the desired results. Also, there may not be feedback as to the alignment of the payload during actual operation of the robots. Over time, payload placement may change due to equipment wear and other factors affecting payload placement, such that the results of subsequent operations may not be uniform over a processing run.

### SUMMARY

According to the methods and systems described herein, a handler robot may be calibrated by determining positions for stations between which the robot will transfer payloads, performing a transfer of a payload by the robot between the stations, measuring an offset and angle of the payload from the determined position of the station to which it was transferred and updating the determined position of that station based on the measured offset and angle.

In one embodiment, the method can measure a baseline offset and angle for sources of positioning errors. One of the sources may be chosen and the method can iteratively change a state of the chosen source and measure an offset and angle for the state, iteratively set the baseline state and return to choose another source when the states of the chosen source have been measured and update the determined position based on the offsets and angles for the states of the sources. A vector sum of the offsets and angles for the states may be used to update the determined position. Statistical analysis of the offsets and angles for a plurality of wafers can also be used to update the determined position.

A system for implementing the method can include fixtures mounted on the stations by which the robot can learn the positions for the stations when the robot may be placed in the respective fixture, a sensor at the second station to measure the offset and angle and a controller to update the learned position of the second station based on the offset and angle.

### BRIEF DESCRIPTION OF THE DRAWINGS

The following figures depict certain illustrative embodiments of the systems and methods in which like reference numerals refer to like elements. These depicted embodiments are to be understood as illustrative and not as limiting in any way.

FIG. 1 shows a schematic representation of a system for transferring a payload between stations; and

FIG. 2 shows a more detailed schematic representation of an orienter station and a load lock station of the system of FIG. 1; and

FIG. 3 shows a flow chart for a method for automated calibration of a robot used in transferring the payload.

### DETAILED DESCRIPTION OF THE PREFERRED EMBODIMENT

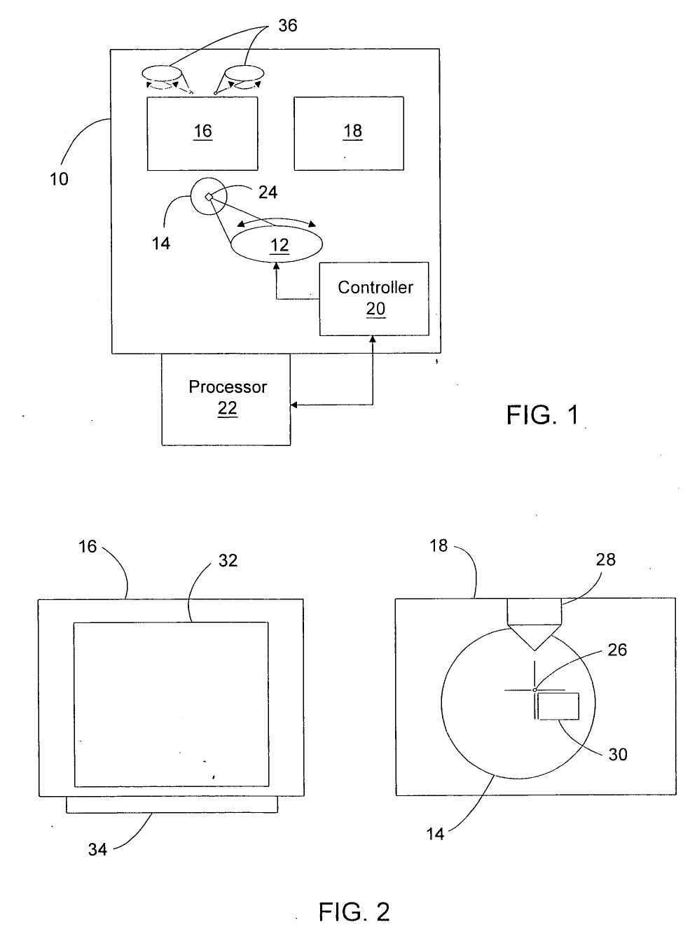

Referring to FIG. 1, there can be shown a schematic representation of a system 10 that may include a robot 12 for transferring a payload 14 between a first station 16 and a second station 18. For the illustrative system 10 of FIG. 1, the first station 16 may be the load lock of system 10 and the second station 18 may be the orienter of system 10. However, it will be appreciated that other stations of system 10 may be adapted for calibrating the robot 12. System 10 may also include a controller 20 to control movement of robot 12. A processing system 22, such as a computer, may be connected to controller 20 to process data to/from controller 20.

Generally, robot 12 may pick a payload, or wafer 14 from first station 16 and position wafer 14 on second station 18. Robot 12 may be taught the position of the stations 16 and 18 using fixtures (not shown) mounted at stations 16 and 18. The fixtures can have a known relationship with the stations they are mounted at. In a learning mode, an end effector 24 of robot 12 can be placed in one of the station fixtures. The robot 12 thus learns the position of the end effector 24 of the robot 12 with respect to the station based on the known relationship of the fixture with the station.

FIG. 2 may illustrate in further detail, the second station 18 of system 10. For the example embodiment of FIGS. 1 and 2, second station 18 may be an orienter as may be known in the art. In order to obtain precise implants, standard implant equipment may include an orienter that can determine the positional offset (eccentricity), angular offset and notch position of the wafer 14 with respect to the orienter axis 26. Orienter 18 may include a measurement device 28 employed to determine the offset of the wafer at orienter 18, such as by a sensor that measures the relative position of the edge of the wafer 14 with respect to the axis of rotation 26 of the orienter 18 as a function of angle.

The wafer 14 can be rotated about the axis 26 and an encoder 30 can be used to measure the angle of rotation. A table of angle and distance to periphery can be generated and the offset and angle to the center of the wafer from the axis of the orienter can be calculated. The measurement device may also determine the location of a notch on the wafer 14, such that the orientation of the wafer 14 can be determined. The offset and angle can be used to correct the taught position of the robot at the orienter 18.

It is required that the taught positions not be at the exact center location of the stations, but that the relative misplacements be the same (as long as the end effector does not physically contact anything in the patch or at the stations). This requirement is met by the initial teaching with fixtures.

To improve throughput of wafers 14, first, or load lock station 16 may include a stack 32 of wafers 14, as may be known in the art. Such load lock stations 16 may have a slot 34 through which the wafers 14 are presented to the robot 12. A cassette plate (not shown) can holds the stack 32 within load lock 16 and an elevator (not shown) may raise or lower the slot 34 to the appropriate wafer 14 position, or alternately, the cassette may be raised or lowered to present a wafer 14 to the slot 34. The error, i.e., the offset and angle, can be a function of the position of slot 34 or stack 32. This may be due to either the cassette plate being out of level, or to the axis of motion of the elevator in load lock 16 not being plumb. The result may be a relative lateral displacement of the wafer 14 for various positions of slot 34 or stack 32. This linear function can be determined by measuring the offset and angle for the various slot positions. The correction to the taught position may be based on the linear function and thus depend on the slot 34 or stack 32 position.

Offsets and angles resulting from other equipment misalignments may also be included in the correction to the taught position. As an example, FIG. 1 illustrates one or more loading robots 36 that may be used to load wafer cassettes into load lock chamber 16. Errors in the teaching process for the robots 36 may cause errors in the placement of the cassettes in the load lock 16 and thus may cause positional errors when the wafers are delivered to the orienter. By holding other causes of error steady, e.g., by using the same position of slot 34 or stack 32, a measure of the error introduced by changing between robots 36 can be obtained. Thus, the correction to the taught position of the orienter can depend on multiple factors. For the illustrated example equipment of FIG. 2, the correction can be a function of the position of the slot 34 or stack 32 and also a function of which loading robot 36 may have been used to load the wafer cassette into the load lock station 16. It can be understood that error measurements may be obtained for multiple wafers and the corrections can be determined based on known statistical analysis methods, e.g. a least squares regression.

Referring back to FIG. 1, the controller 20 may store the corrections and correction functions so that the robot 12 taught positions can be appropriately corrected so as to transfer the wafers 14 between stations more accurately. Processing system 22 may perform the statistical analyses and other calculations as may be required to determine the corrections or correction functions. The controller 20 may also control the operation of the system 10 components to obtain individual corrections or correction functions for the various components, as described in relation to the location of the slot 34 or stack 32 and the misalignment of loading robots 36.

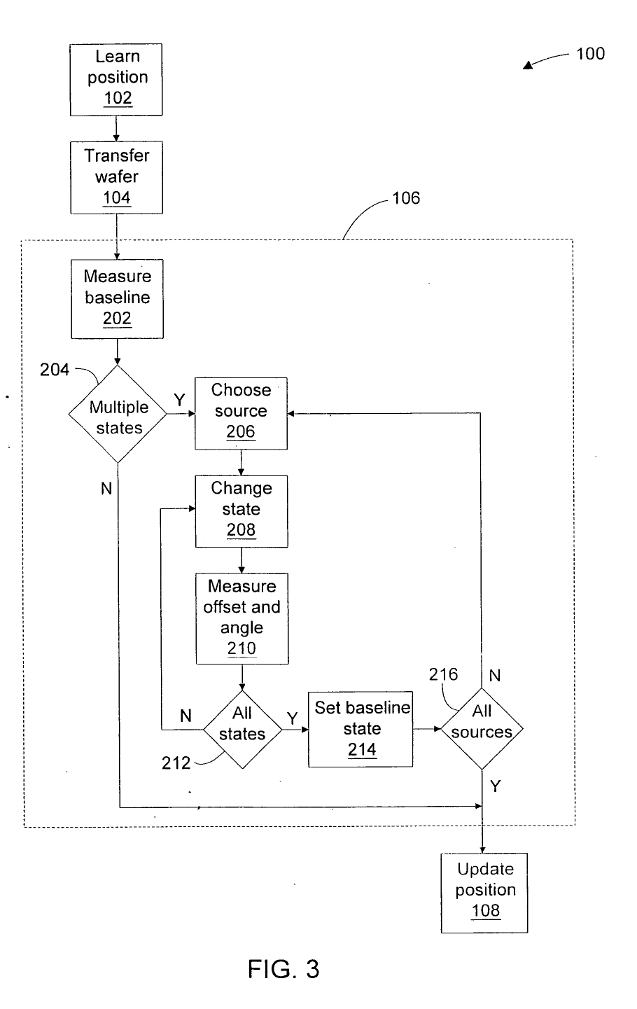

FIG. 3 illustrates a flow chart of a method 100 for calibrating the robot 12. At 102, robot 12 may learn the positions of the first and second stations 16, 18 in a manner known in the art. As previously described, fixtures may be placed on the stations and the end effector 24 of robot 12 may be placed on the fixture and the position recorded. Other learning methods as may be known can also be used without limitation to the method 100 described herein.

Using the taught position, robot 12 may then transfer a wafer 14 from the first station 16 to the second station 18, as shown at 104. Second station 18 may be equipped with means to measure the offset and angle of the center of the wafer 14 with respect to a position on the second station, such as may be found in orienter stations known in the art. However, it can be seen that the method 100 may be implemented with the use of other stations that may be equipped with such measurement means. At 106, the offset and angle can be measured and stored and the measured error, i.e., the offset and angle, can be used to update the taught position at 108.

As previously described, errors in positioning may be introduced through various sources. When error sources may have multiple states, e.g., the location of slot 34 or stack 32 and the loading robot 36 used, measuring and storing the offset and angle at 106 may require determining the offset and angle for individual states and can include measuring a baseline offset and angle at 202. If system 10 may not include sources with multiple states, the baseline offset and angle may be used to update the taught position at 108.

If system 10 may include sources with multiple states, as determined at 204, one of the sources with multiple states is chosen at 206. The state is changed at 208 and the offset and angle with the changed state is measured and stored at 210 until all states may have been measured, as determined at 212. When all states have been measured, the baseline may be reset, as shown at 214. A new source with multiple states is chosen at 206 and the process of 208, 210 is repeated until all multiple state sources have been chosen, as determined at 216. When all multiple state sources can have been chosen, a vector summation of the offsets and angles for the particular states of the sources at which system 10 may be operating may be used to update the taught position at 108.

While the methods and systems have been disclosed in connection with the preferred embodiments shown and described in detail, various modifications and improvements thereon will become readily apparent to those skilled in the art. As an example, method 100 may be enhanced through statistical analysis of data obtained by repeating the measuring and storing at 106 for multiple wafers. When operation of system 10 may transfer a wafer to the second station 18, the offset(s) and angle(s) for the wafer may be determined at 106. The updating of the position at 108 may include the statistical analysis of the offsets and angles for the wafers that have been measured.

Further, those with ordinary skill in the art can recognize that the arrangement of the components shown in FIGS. 1 and 2 and the items shown in FIG. 3 may be merely for illustrative purposes and can be varied to suit the particular implementation of interest. Accordingly, items may be combined, expanded, or otherwise reconfigured without departing from the scope of the disclosed methods. As an example, that processing system 22 may be a part of or separate from controller 20. Further, processing system 22 may be separate from, but connected to system 10, or system 10 may include processing system 22.

The methods and systems described herein may not be limited to particular hardware or software configuration, and may find applicability in many processing environments where robots may be used to position a payload at a station. The methods can be implemented in hardware or software, or a combination of hardware and software. The methods can be implemented in one or more computer programs executing on one or more programmable computers that include a processor, a storage medium readable by the processor, one or more input devices, and one or more output devices. In some embodiments, such as that of FIG. 1, a processing system may be used. In other embodiments, the methods may be implemented on a computer in a network. User control for the systems and methods may be provided through known user interfaces.

The computer program, or programs, may be preferably implemented using one or more high level procedural or object-oriented programming languages to communicate with a computer system; however, the programs can be implemented in assembly or machine language, if desired. The language can be compiled or interpreted.

The computer programs can be preferably stored on a storage medium or device (e.g., CD-ROM, hard disk, or magnetic disk) readable by a general or special purpose programmable computer for configuring and operating the computer when the storage medium or device may be read by the computer to perform the procedures described herein. The method and system can also be considered to be implemented as a computer-readable storage medium, configured with a computer program, where the storage medium so configured may cause a computer to operate in a specific and predefined manner.

The aforementioned changes may also be merely illustrative and not exhaustive, and other changes can be implemented. Accordingly, many additional changes in the details and arrangement of parts, herein described and illustrated, can be made by those skilled in the art. It will thus be understood that the following claims may not to be limited to the embodiments disclosed herein. The claims can include practices otherwise than specifically described and are to be interpreted as broadly as allowed under the law.

1. A method of calibrating a handler robot, comprising:
determining positions for a first station and a second station between which the robot will transfer payloads;
performing a transfer of a payload by the robot from the first station to the second station;
measuring an offset and angle of the payload from the determined position of the second station; and
updating the determined position of the second station based on the measured offset and angle.

2. The method of claim 1, wherein the measuring comprises measuring a baseline offset and angle for sources of positioning errors.

3. The method of claim 2, comprising:
choosing one of the sources;
iteratively changing a state of the chosen source and measuring an offset and angle for the state;
iteratively setting the baseline state and returning to choose another source when the states of the chosen source have been measured; and
updating the determined position based on the offsets and angles for the states of the sources.

4. The method of claim 3, wherein updating the position comprises obtaining a vector sum of the offsets and angles for the states.

5. The method of claim 1, wherein updating the position comprises performing a statistical analysis of the offsets and angles for a plurality of wafers transferred to the second station.

6. A system for calibrating a handler robot, comprising:
means for determining positions for a first station and a second station between which the robot will transfer payloads;
means for measuring an offset and angle of the payload from the determined position of the second station when the robot has transferred the payload from the first station to the second station; and
means for updating the determined position of the second station based on the measured offset and angle.

7. A system for calibrating a handler robot, comprising:
respective fixtures mounted on a first station and a second station, the robot learning positions for the first station and the second station when placed in the respective fixture;
at least one sensor to measure an offset and angle, with respect to an axis of the second station, of a payload placed on the second station by the robot; and
a controller to update the learned position of the second station based on the offset and angle.

8. A computer-readable medium containing instructions for controlling a computer system to calibrate a handler robot by:
determining positions for a first station and a second station between which the robot will transfer payloads;
performing a transfer of a payload by the robot from the first station to the second station;
measuring an offset and angle of the payload from the determined position of the second station; and
updating the determined position of the second station based on the measured offset and angle.
